(19) United States
(12) Patent Application Publication
(10) Pub. No.: US 2006/0271509 A1
(43) Pub. Date: Nov. 30, 2006

(54) Apparatus and method for augmenting a report with parameter binding metadata

(76) Inventors: Ju Wu, Coquitlam (CA); Qian Wu, Anmore (CA); Yan Dong, Coquitlam (CA); Patrick Yee Cheuk Cheng, Vancouver (CA)

Correspondence Address: Cooly Godward LLP;ATTN: Patent Group, Five Palo Alto Square, 3000 El Camino Real, Palo Alto, CA, 94306-2155, US

(21) Appl. No.: 11/318,333

(22) Filed: Dec. 23, 2005

Related U.S. Application Data
(63) Continuation-in-part of application No. 11/137,710, filed on May 24, 2005.
(60) Provisional application No. 60/719,789, filed on Sep. 23, 2005.

(51) Int. Cl. G06F 17/30

(52) U.S. Cl. 707/2

(57) ABSTRACT

A computer readable medium includes executable instructions to create a report; augment the report with metadata including information specifying a parameter within the report; and export at least a portion of the report and the metadata to a non-report electronic document.

### CROSS-REFERENCE TO RELATED APPLICATION

This application is a continuation-in-part of pending U.S. Ser. No. 11/137,710, filed May 24, 2005, entitled “Apparatus and Method for Inserting Portions of Reports into Electronic Documents”, the contents of which are incorporated by reference. This application also claims priority to the U.S. Ser. No. 60/719,789, filed September 23, 2005, entitled “Apparatus and Method for Augmenting a Report with Parameter Binding Metadata”, the contents of which are incorporated by reference.

### BRIEF DESCRIPTION OF THE INVENTION

The present invention relates generally to utilizing electronic reports. More particularly, the present invention relates to utilizing electronic reports in non-report documents.

### BACKGROUND OF THE INVENTION

There are a number of commercially available products to produce reports from stored data. For instance, Business Objects Americas of San Jose, Calif., sells a number of widely used report generation products, including Crystal Reports™, Business Objects OLAP Intelligence ™, and Business Objects Enterprise™. As used herein, the term report refers to information automatically retrieved (i.e., in response to computer executable instructions) from a data source (e.g., a database, a data warehouse, and the like), where the information is structured in accordance with a report schema that specifies the form in which the information should be presented. A non-report is an electronic document that is constructed without the automatic retrieval (i.e., in response to computer executable instructions) of information from a data source. Examples of non-report electronic documents include typical business application documents, such as a word processor document, a spreadsheet document, a presentation document, and the like.

A report document is generally created by a specialized tool including executable instructions to access and format data. A report document where the content does not include external data, either saved within the report or accessed live, is a template document for a report rather than a report document. Unlike, other non-report documents that may optionally import external data within a document, a report document by design is primarily a medium for accessing, formatting, and presenting external data.

A report design tool contains executable instructions specifically designed to facilitate working with external data sources. In addition to instructions regarding external data source connection drivers, these instructions may include advanced filtering of data, instructions for combining data from different external data sources, instructions for updating join structures and relationships in report data, and instructions including logic to support a more complex internal data model (that may include additional constraints, relationships, and metadata).

In contrast to a spreadsheet type application, a report generation tool generally is not limited to a table structure but can support a range of structures. A report design tool is designed primarily to support imported external data, whereas a spreadsheet application equally facilitates manually entered data and imported data. In both cases, a spreadsheet application applies a spatial logic that is based on the table cell layout within the spreadsheet in order to interpret data and perform calculations on the data. In contrast, a report design tool is not limited to logic that is based on the display of the data, but rather can interpret the data and perform calculations based on the original (or a redefined) data structure and meaning of the imported data. Spreadsheet applications work within a looping calculation model, whereas report generation tools may support a range of calculation models. Although there may be an overlap in the function of a spreadsheet document and a report document, the applications used to generate these documents contain instructions with different assumptions concerning the existence of an external data source and different logical approaches to interpreting and manipulating imported data.

The commonly owned parent patent application entitled “Apparatus and Method for Inserting Portions of Reports into Electronic Documents”, U.S. Ser. No. 11/137,710, filed May 24, 2005, discloses techniques for adding metadata to a portion of a report and then exporting the portion of the report and the associated metadata to a non-report electronic document. The contents of the foregoing application are incorporated herein by reference. It would be highly desirable to extend the functionality of the technology described in the foregoing application to include entire reports. In particular, it would be highly desirable to export entire reports into non-report electronic documents, while still allowing refresh and related operations on the exported report. It would also be desirable to bind parameters between report objects and non-report documents to enhance functionality and flexibility when using, updating, and refreshing report data within a non-report document.

It is against this background that a need arose to develop the apparatus and method described herein.

### SUMMARY OF THE INVENTION

The invention includes a computer readable medium with executable instructions to create a report; augment the report with metadata including information specifying a parameter within the report; and export at least a portion of the report and the metadata to a non-report electronic document.

The invention also includes a computer readable medium with executable instructions to receive at a non-report document at least a portion of a report and metadata specifying a parameter associated with at least a portion of the report; and analyze the metadata to initiate a refresh of at least a portion of the report.

The invention also includes a computer readable medium with executable instructions to bind an object in a non-report document to an object in a report document; receive a value at the object in the non-report document; associate the value with the bound object in the report document; refresh the report document in response to the value to produce refreshed report data; and import the refreshed report data into the non-report document.

The invention provides unique functionality in the export of information and the facilitation of refresh operations from a non-report document using parameter values. The invention provide a degree of functionality that makes the exported report document much more useful to business users who are able to refresh the data such that there is a meaningful degree of focus/limitation placed on the data that is displayed when the data in the exported report document has its data refreshed. The additional ability to specify the parameter value based on a spreadsheet cell (e.g., an Excel™ cell), provides the ability to refresh report data so that the parameters applied are based on formulas that may factor in other attributes that are not available within the context of the original report document. From a user perspective this functionality will significantly improve a workflow that would have historically meant that the calculation would be performed in the non-report document (such as Excel™) and then a separate reporting application/report document would be used. In Excel™, a user can specify a query/data source, but one must manually add the parameter specification to a query file. Thus, this information is not contained within the imported data and does not provide prompting for values.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates processing operations associated with an embodiment of the invention.

FIG. 2 illustrates components and process flow associated with an embodiment of the invention.

FIG. 3 illustrates a graphical user interface that may be used in accordance with an embodiment of the invention.

FIG. 4 illustrates components and process flow associated with an alternate embodiment of the invention.

FIG. 5 illustrates parameter binding operations performed in accordance with an embodiment of the invention.

FIG. 6 illustrates parameter binding operations in accordance with an embodiment of the invention.

FIG. 7 illustrates a graphical user interface that may be utilized in accordance with an embodiment of the invention.

FIG. 8 illustrates a graphical user interface that may be utilized in accordance with an embodiment of the invention.

FIG. 9 illustrates another graphical user interface that may be utilized in accordance with an embodiment of the invention.

Like reference numerals refer to corresponding parts throughout the several views of the drawings.

### DETAILED DESCRIPTION

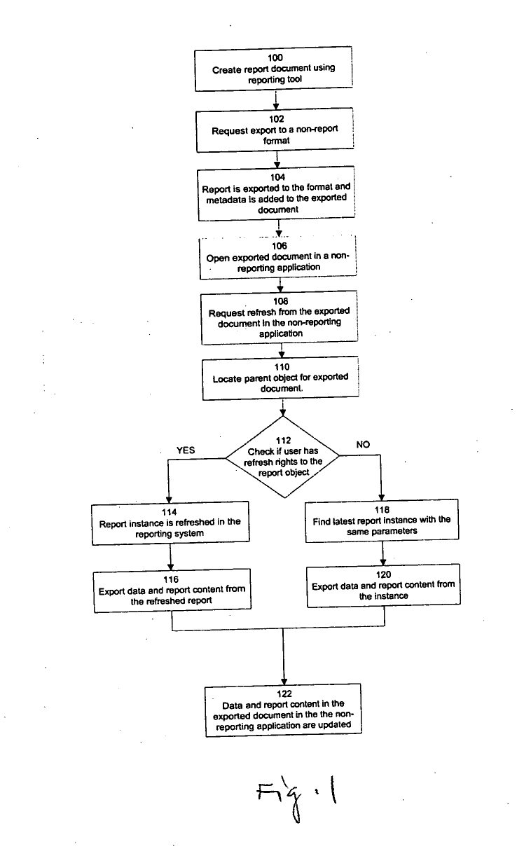

FIG. 1 illustrates processing operations associated with an embodiment of the invention. Initially, a report document is created using a reporting tool 100. A request is then processed for the export of the report to a non-report document 102. Metadata is then added to the report. Various forms of metadata used in accordance with embodiments of the invention are discussed below. The report and the metadata are then exported 104. The report and the metadata are then opened in a non-reporting application 106. The non-reporting application may be on the same computer or a different computer than the computer that generated the report. Typically, one computer will generate a report and export the report (with the metadata) over a network to a second computer. Next, a request to refresh the report is processed 108. The parent object for the exported document is then located 110. A check is then made to determine if the user has refresh rights to the report object 112. If so, the report instance is refreshed in the reporting system 114. The data and report content from the refreshed report is then exported to the non-report document 116. If the user does not have refresh rights, the latest report instance with the same parameters is identified 118. Data and report content from this instance is then exported to the non-report document 116. Finally, data and report content in the non-report document are updated 122.

The invention combines functionality from a reporting system in terms of creating the export document and coordinating a report refresh with functionality in a non-reporting application such as Microsoft™ Word™ or Excel™. The report document is exported in order to be compatible with these non-reporting applications. Metadata regarding the original source report and its data sources is added to the exported document. At a minimum, the metadata provides information for identifying the source report and the parameters used within the source report. It can include additional metadata such as report server name, drill down path information, export dll information, export format and options, prompts for the report, logon information (UserID, but not password stored), report language, etc. The metadata system is extensible.

With the exported document open in the non-reporting application, it is possible to trigger a refresh of the source report (or to open an existing instance of the report document) and to import the updated data/report content into the exported document within the non-reporting application.

Refresh options are based on having permission to refresh the report object. In one implementation, an additional range of options exist for selecting whether to refresh the non-report document by refreshing the report, accessing the latest report instance, or selecting a specific report instance. Additionally, options for how to handle the refresh in the non-report document include: replacing all of the existing report content, inserting the new report content in a new page, creating trending information based on the original report data as it compares with the updated report data, maintaining modifications in the non-report document including formatting changes to the original report data and additional content.

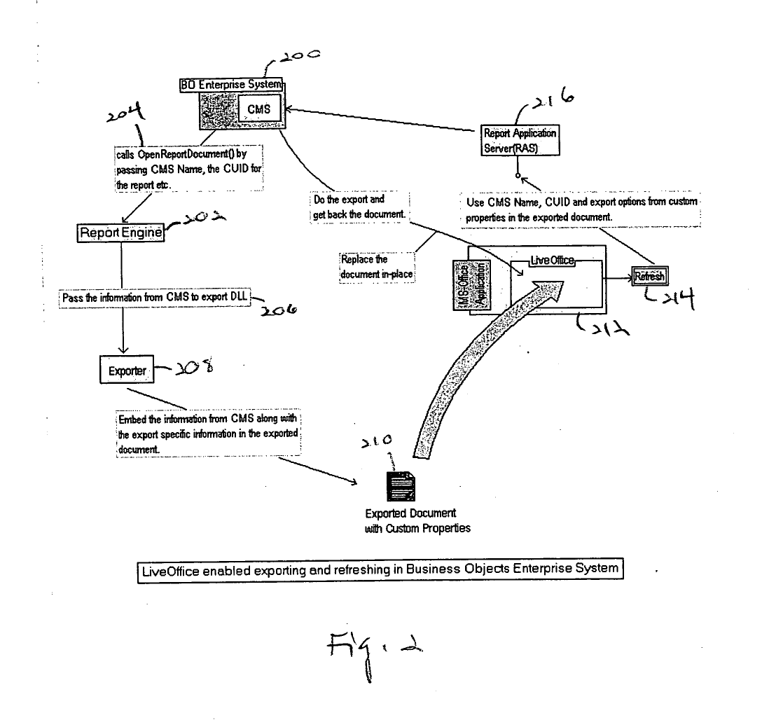

FIG. 2 provides a more detailed overview of components and processing operations associated with an embodiment of the invention. The following example is in the context of non-reporting applications sold by Microsoft Corporation, Redmond, Wash., and reporting applications sold by Business Objects Americas, San Jose Calif. To enable the exported documents for Microsoft's LiveOffice product, some custom information is embedded in the exported document, during the export time. This custom information is subsequently used by LiveOffice.

The processing associated with FIG. 2 can be characterized as follows:
a. When a Business Objects Enterprise server 200 opens a report document using a Report Engine 202, it passes in information 204 about the server name (e.g., the name of the CMS server) and the report ID (e.g., the report CUID).
b. The Report Engine 202 then stores this information. When an export call is made from the Business Objects Enterprise side, Report Engine 202 passes this information 206.
c. The Exporter or Export DLL 208 then uses this information and appends any additional information (like the export format DLL name, the format type, the format options, etc.) and creates a string in a pre-determined syntax. The syntax of this string is mutually agreed upon between the export DLL 208 and the non-report application (e.g., LiveOffice 212). This string is then encrypted and embedded in the exported document as a custom property. LiveOffice exporting is enabled by default, but can be turned off. This results in an exported document with custom properties 210.

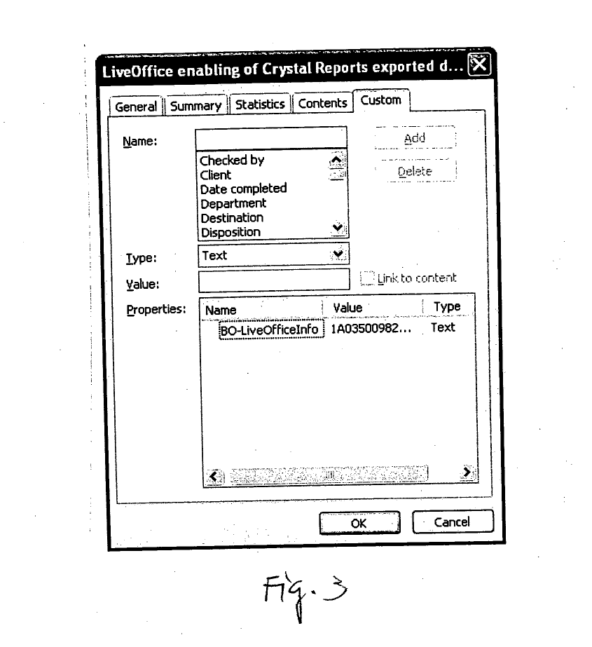

FIG. 3 illustrates an example of the custom property for the exported document when opened in a non-report application (e.g., an MS-Office application). FIG. 3 illustrates a properties field with a BO-LiveOfficelnfo file specified. Note that the property is encrypted for security purposes. The custom property set like this does not create any compatibility problems in the exported document, as it does not affect the data area of the document.

Returning to FIG. 2, the exported document is processed as follows.
d. A user opens the document in a non-report application 212 (e.g., MS-Office that has a LiveOffice plug-in). In LiveOffice, along with other UI elements, there is an option to ‘Refresh’ 214 the document.
e. LiveOffice then reads the custom property from the document and decrypts it (the encryption method is also mutually agreed upon between export DLL and LiveOffice). Once decrypted, it parses the string, and then talks (e.g., through a report application server 216) to the specified server (e.g., CMS server 200) with the relevant information. Then it gets the document re-exported through Business Objects Enterprise 200 and replaces the document in-place in the MS-Office application 212.

Within the LiveOffice context, when the meta-data for the report is accessed, the parent object for the report is identified and located. If the user has refresh rights, the report object is used to refresh and get the latest context. If the user does not have refresh rights, the latest report instance running with the same parameter values is used to get the new content.

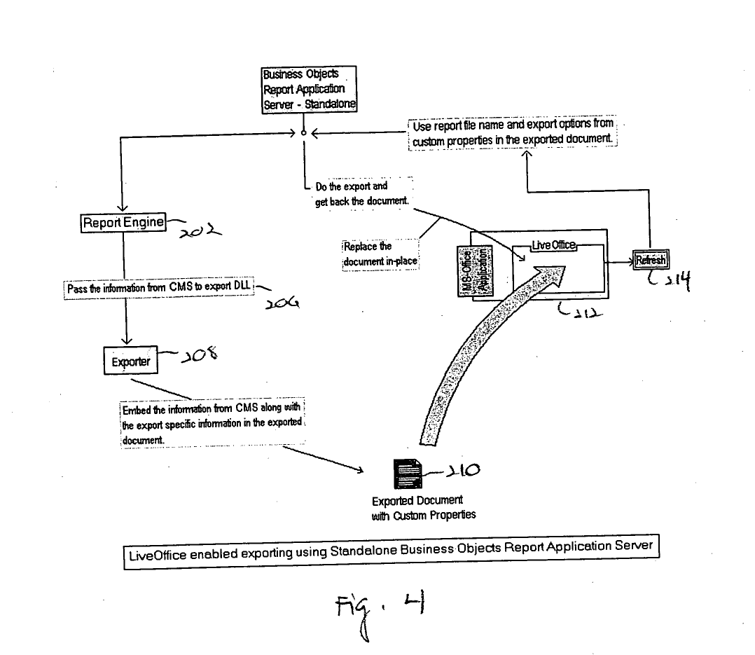

FIG. 4 illustrates an unmanaged LiveOffice implementation in which the Business Objects Enterprise system is absent. Therefore, the CMS Name and the report CUID are not used. Instead the ‘report name’ and optionally report parameters are used. The LiveOffice client uses the report name embedded in the exported document to refresh. Other than this difference, the rest of this workflow is same as in FIG. 2.

The unmanaged LiveOffice workflow enables systems that do not include the Business Objects Enterprise system to create metadata when a report object is exported such that the exported document based on a report document can be refreshed.

The following table lists various metadata that may be attached to a file in accordance with various embodiments of the invention.

| | |
|---|---|
| CMSName | The name of the CMS server. |
| CUID | The CUID (or report ID) for the report in |
| | the Business Objects Enterprise |
| LocalReportFileName | The path name of the report file. This will |
| | be used by Unmanaged LiveOffice. |
| DrillDownContext<token | The group path of the Drill Down context |
| separator> | to use, if the document is exported from a |
| | drill down view. This string will have a |
| | format like “0-4-6” i.e., numbers separated |
| | by hyphen (‘-’). |
| ParameterInfo | This is the name and value of the |
| | parameters used for the report. The syntax |
| | of the <report parameter info> is as |
| | follows: |
| | <param Name>“[“<param value>”]” for |
| | each parameter. If there is more than one |
| | value for the parameter, they are comma |
| | separated. |
| | For parameters with multiple values, all the |
| | values are encoded in a single string. |
| | For instance, assume the following case: |
| | Country = “Canada” |
| | Provinces = “BC”, “ON” |
| | Cities = “Vancouver”, “St, Edwards” |
| | The embedded string should be |
| | ParameterInfo= |
| | Country[Canada] |
| | Provinces[BC,ON] |
| | Cities[Vancouver,St\002C |
| | Edwards] |
| ExportDllId | The name of the export DLL used to create |
| | this document. For instance, crxf_xls.dll, |
| | crxf_rtf.dll etc. |
| ExportFormatIndex | The index of the export format. For |
| | instance, 1 for “RTFEditable” when export |
| | DLL is crxf_rtf. |
| ExportOptions | The format options used for the export. |
| | This will be a string of properties. If this |
| | string contains any of the reserved |
| | characters, then they are escaped. |

An embodiment of the invention relates to the use of parameters in the metadata sent to a non-report document. The parameters relate to report attributes. The parameters are used with metadata that is transported with a portion of a report or an entire report. This feature allows one to bind parameters from report documents in a reporting system to documents in a non-reporting system.

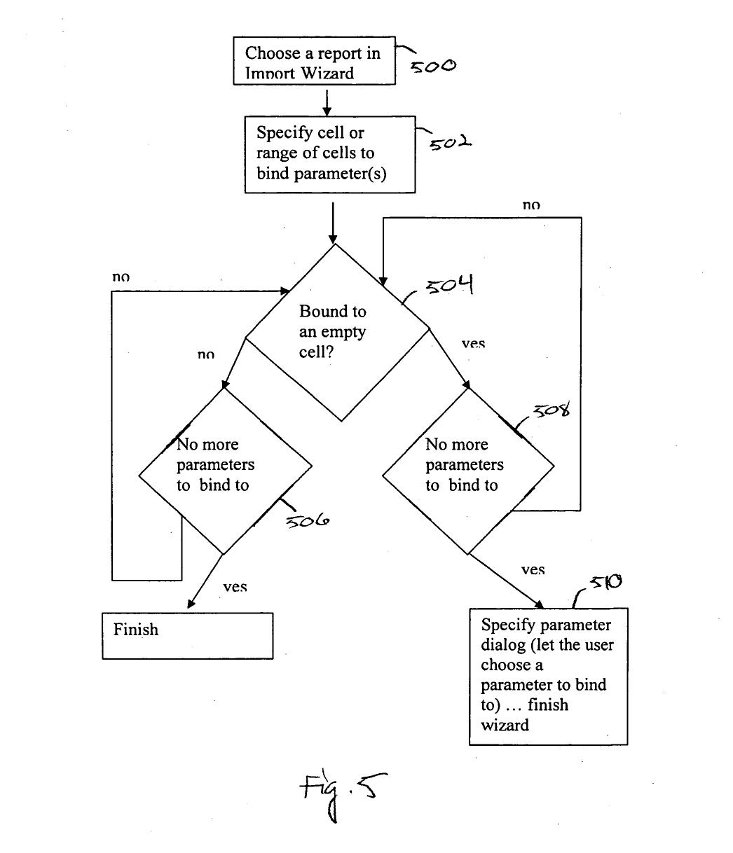

FIG. 5 illustrates parameter binding operations in accordance with an embodiment of the invention. Initially, a report is chosen 500. A cell within the report or a range of cells is then specified to bind parameter(s) 502. Processing proceeds through blocks 504-510 until all parameters are bound to all specified cells.

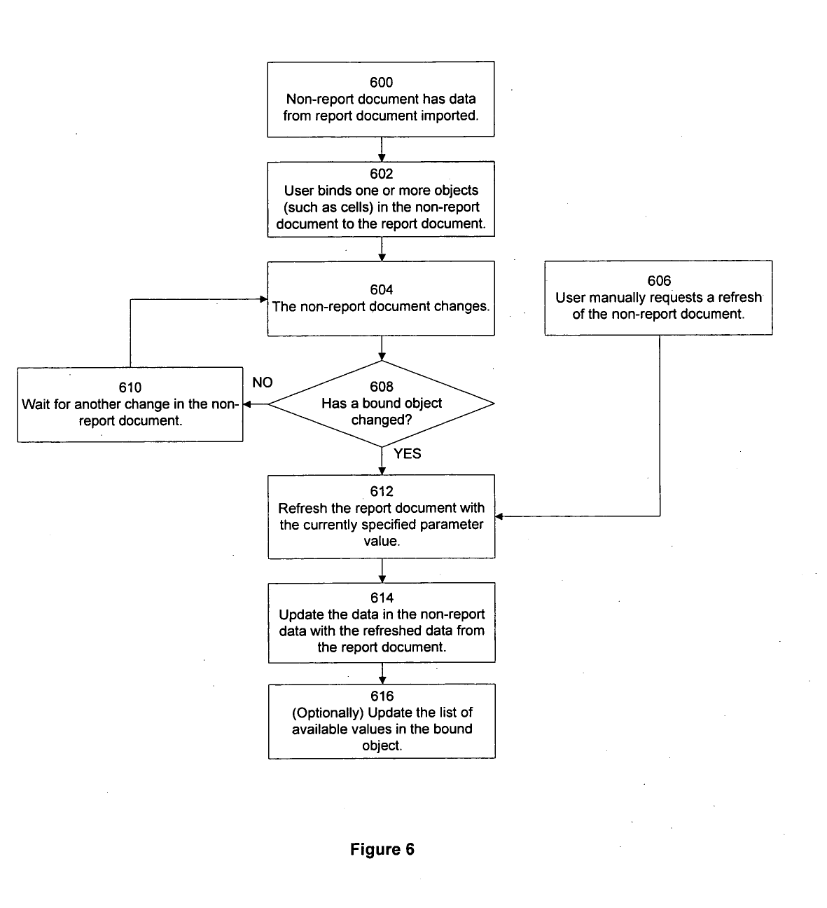

FIG. 6 illustrates parameter binding operations in accordance with an embodiment of the invention. Initially, a non-report document has data from a report imported 600. The user binds one or more objects (typically cells) in the non-report document to the report document. In one embodiment, these parameter values are bound to parameters within the report document. In another embodiment, these values can be bound to other values (such as functions) within the report document. If the non-report document changes 604 it is determined whether any of the bound objects have changed 608. In one embodiment of the invention, depending on user preferences, a change in the non-report document triggers the attempt to refresh and in another embodiment this is triggered manually by the user 606. The user may trigger a refresh that is not on a parameter change, but on a desire to refresh the data using the current parameter. In the case that a change in the document has been automatically detected 604, a check is made to confirm whether a bound object has changed 608 and if there has been no change the process continues to wait for a change in the non-report document 610. If a bound object has changed, or if the refresh request was manual 606, the report document is refreshed with the currently specified parameter 612. The data in the non-report document is refreshed based on the refreshed data in the report document 614. If the bound parameter is based on a list of values from the report document, optionally, this list of values for the bound object is refreshed when the other data values from the report document are refreshed in the non-report document.

The bound objects within the non-report document can be either a single object or a range of objects. For example, there might be a number of cells in the non-report document that each specified a country name. Each of these cells could be used to create a list of parameters that specified the country parameters that were applied when the report was refreshed or a range of values used within a function in the report document on refresh.

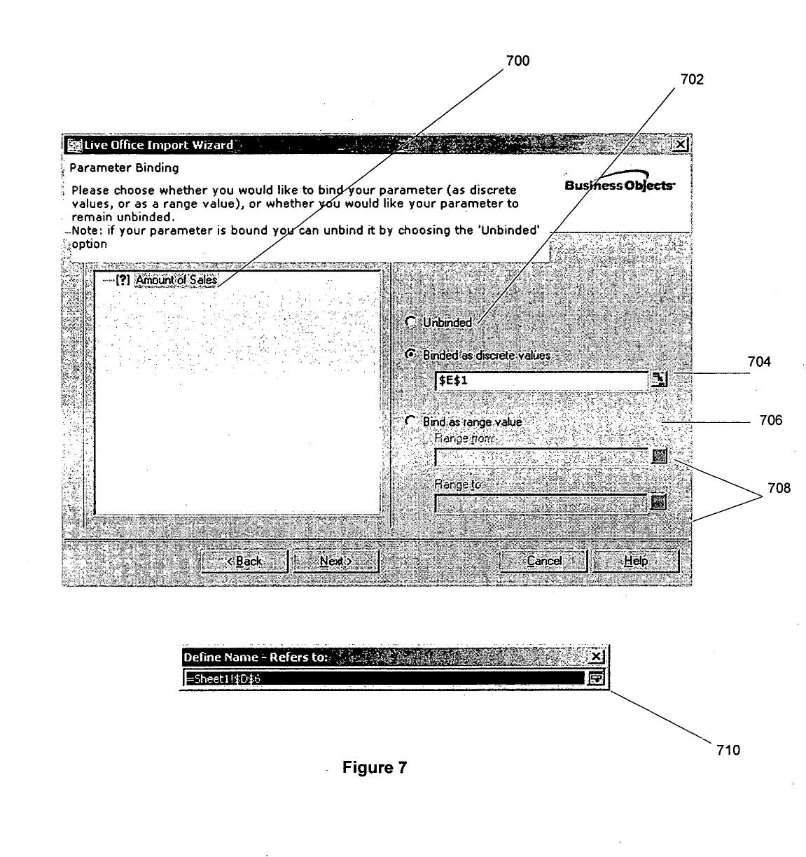

FIG. 7 illustrates a graphical user interface associated with one embodiment of the invention. This graphical user interface facilitates associating objects within a non-report document with values such as parameters and function variables within the report document. Section 700 indicates the elements within the report document that are available for binding. The user is able to select whether to remove a binding 702 or bind a discrete value 704 or a range of values 706 and then to specify the range 708. The graphical user interface will display the binding relationship when the user clicks on the cell object 710.

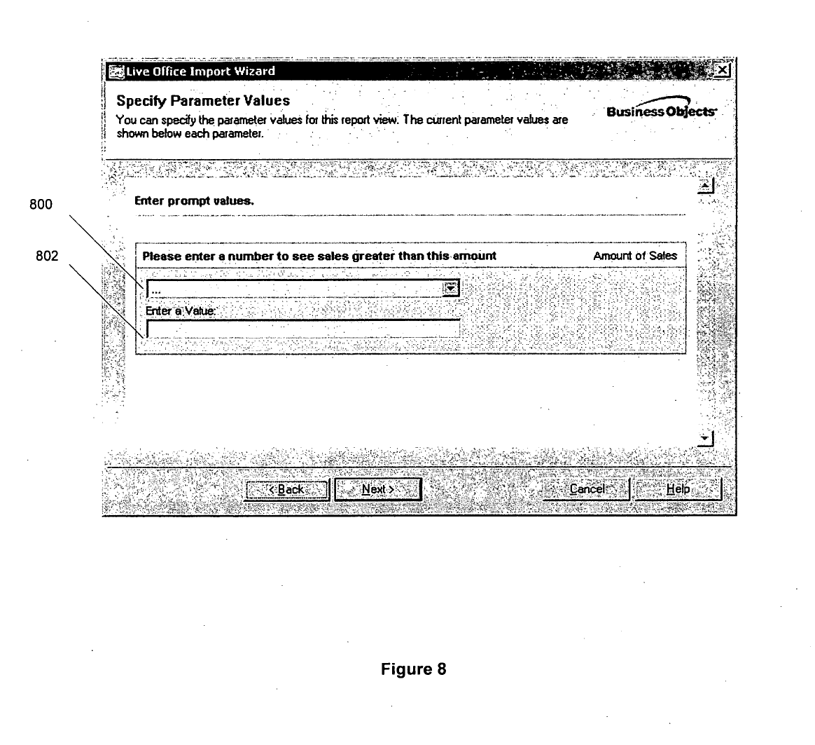

FIG. 8 illustrates a graphical user interface associated with one embodiment of the invention. This graphical user interface facilitates associating objects within a non-report document with values such as parameters and function variables within the report document. This graphical user interface is used to specify the initial or new values within the non-report document that are mapped to the report document. A value can be selected from a list of values 800 or entered manually 802, depending on what the parameter cell is bound to.

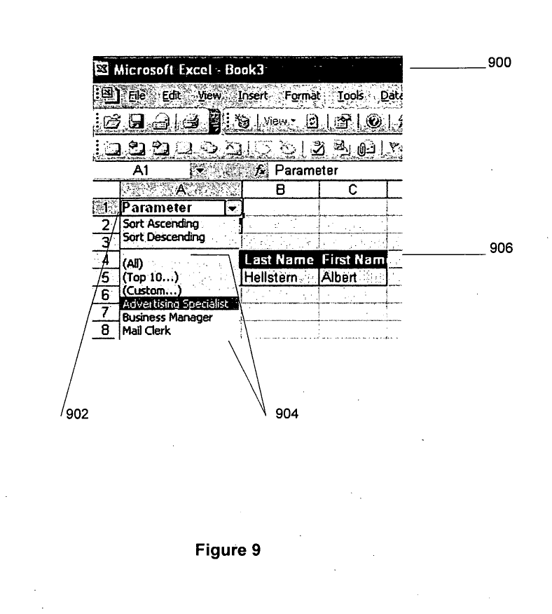

FIG. 9 illustrates a graphical user interface associated with one embodiment of the invention. A list of values parameter is imported within a standard non-report document graphical user interface such that the user is able to select a value based on the list of values contained within the report document. By selecting a value 902 from the list of values 904, the user is able to specify the parameter value that is passed from the non-report document to the report document to update the data displayed in the non-report document 906. This value selected within the non-report document is passed to the report document where the data is refreshed in the report document based on this value and then passed back to the non-report document. Depending on the parameter in the report document that the parameter in the non-report document is bound to, the non-report document object could have additional features enabled such as a dropdown list, comments, notes, such that values associated with parameter in the report document that might be used to assist the user to supply a valid or correct value in the non-report document.

Embodiments of the invention support the following features:
Two types of Refresh methods:

Refresh with New (refresh with new values and re-prompt the user—see table below)

Refresh with Current (use the values that were used last)
By default, the feature may refresh as soon as the value is chosen. A menu option may be used to select or deselect this default setting.
If the value bound is a DCP (Dynamic Cascading Parameter) the workflow for binding will accommodate the logic between the parameter levels.
Support insertion of bound parameter(s) from Crystal Reports, Web Intelligence, and other document types to single or multiple cells in Excel.
Support populating the bound parameters with a chosen list of the parameter values.
New Options for parameter binding:

A global and view level option for whether the binding cell changes should resolve a re-rendering to the view (with the change applied) right away. e.g., update view when binding cell changes—on by Default
Link parameter to existing value in cell

A wizard may be used to link to a cell that already has a value in it and determine whether to re-prompt the user to specify a parameter value. In one embodiment of the invention, the workflow is as follows:
Linked Parameters between Views

There are chances that parameters are binding to cells in a view. For instance, there are two views, “Product (1,1)” and “World Sales Report (2,1)” in the document. The parameter “country” for view “Product (1,1)” is binding to cells in view “World Sales Report (2,1)”. In this case, a “World Sales Report (2,1)” view change during refreshing will affect the view “Product (1,1)”. In this case, one determines the dependency relationship for views in the Excel document so that refresh/rendering of views is performed in the right order.

The invention may be implemented using any number of parameters. The following list is exemplary.
Boolean: Requires a yes/no or true/false answer.
   Example: Include planned budget numbers in the summary?
Currency: Requires a dollar amount.
   Example: Display customers with sales over $X.
Date: Requires an answer in a date format.
   Example: Enter the start and end dates of the quarter.
DateTime: Requires both date and time.
   Example: Display statistics for Jul. 4, 1999 between 1:00 p.m. and 2:00 p.m.
   Parameter Fields and Prompts
Number: Requires a numeric value.
   Example: Enter the customer identification number.
String: Requires a text answer.
   Example: Enter the region.
Time: Requires an answer using a time format.
   Example: Display the total number of calls from 1:00 p.m. to 2:00 p.m.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”), ROM devices, and RAM devices. Examples of computer code include machine code, such as produced by a compiler, and files containing higher level code that are executed by a computer using an interpreter. For example, an embodiment of the invention may be implemented using Java , C++, or other object-oriented programming language and development tools. Another embodiment of the invention may be implemented in hardwired circuitry in place of, or in combination with, machine-executable software instructions.

While the present invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, process step or steps, to the objective, spirit and scope of the present invention. All such modifications are intended to be within the scope of the claims appended hereto. In particular, while the methods disclosed herein have been described with reference to particular steps performed in a particular order, it will be understood that these steps may be combined, sub-divided, or re-ordered to form an equivalent method without departing from the teachings of the present invention. Accordingly, unless specifically indicated herein, the order and grouping of the steps is not a limitation of the present invention.

1. A computer readable medium comprising executable instructions to:
create a report;
augment the report with metadata including information specifying a parameter within the report; and
export at least a portion of the report and the metadata to a non-report electronic document.

2. The computer readable medium of claim I wherein a parameter is selected from a Boolean value, a date, a time, a number, and a text string.

3. A computer readable medium comprising executable instructions to:
receive at a non-report document at least a portion of a report and metadata specifying a parameter associated with at least a portion of the report;
analyze the metadata to initiate a refresh of the report.

4. The computer readable medium of claim 3 further comprising executable instructions to import refreshed report data into the non-report document.

5. A computer readable medium comprising executable instructions to:
bind an object in a non-report document to an object in a report document;
receive a value at the object in the non-report document;
associate the value with the bound object in the report document;
refresh the report document in response to the value to produce refreshed report data; and
import the refreshed report data into the non-report document.

6. The computer readable medium of claim 5 wherein the object in the non-report document is a cell.

7. The computer readable medium of claim 5 further comprising executable instructions to refresh formulas and calculated values within the report document.

8. The computer readable medium of claim 5 further comprising executable instructions to import into the non-report document metadata related to the object in the report document.

9. The computer readable medium of claim 5 further comprising executable instructions to maintain non-report document formatting when adding refreshed data from a report document.

10. A computer readable medium comprising executable instructions to:
bind an object in a non-report document to a report document;
refresh the report document to form a refreshed report document; and
update the non-report document with data from the refreshed report document.

11. The computer readable medium of claim 10 further comprising executable instructions to detect a change to the non-report document, wherein the refresh of the report document is in response to the change to the non-report document.

12. The computer readable medium of claim 11 further comprising executable instructions to detect a change to a parameter associated with the object in the non-report document.

13. The computer readable medium of claim 10 wherein the refresh of the report document is triggered by a user.

14. The computer readable medium of claim 13 further comprising executable instructions to refresh the report document using a parameter value associated with the object in the non-report document.

15. The computer readable medium of claim 14 further comprising executable instructions to update a list of parameter values available to the object in the non-report document.

16. The computer readable medium of claim 15 wherein the parameter values are selected from a list of parameter values in the report document.

17. The computer readable medium of claim 16 wherein the list of parameter values in the report document is refreshed when the report document is refreshed.

18. The computer readable medium of claim 10 wherein the object in the non-report document is bound to a parameter in the report document.

19. The computer readable medium of claim 10 wherein the object in the non-report document is bound to a function in the report document.

20. The computer readable medium of claim 10 wherein the object in the non-report document is a cell.
